(19) United States
(12) Patent Application Publication
(10) Pub. No.: US 2023/0356726 A1
(43) Pub. Date: Nov. 9, 2023

(54) Method and Apparatus for Determining a Parking Position of a Bike

(71) Applicant: Robert Bosch GmbH, Stuttgart (DE)

(72) Inventors: Gustav Traeff, Lund (SE); Jakob Andren, Lund (SE); Linnea Andersson, Lund (SE)

(21) Appl. No.: 18/311,718

(22) Filed: May 3, 2023

(30) Foreign Application Priority Data
May 4, 2022 (DE) 102022204409.6

(51) Int. Cl. B60W 40/105

(52) U.S. Cl. CPC B60W 40/105; B60W 2554/4041; B60W 2300/36

(57) ABSTRACT

A method and an apparatus for determining a parking position of a vehicle is disclosed. The method includes (i) detecting first positions of the vehicle in a temporally successive sequence by a GNSS receiver and storing these positions in a memory, wherein an associated first positioning error is stored for each of the positions, (ii) detecting a final position of the vehicle with an associated final positioning error by the GNSS receiver in response to the vehicle being transferred into a parked state, and (iii) determining the parking position of the vehicle, wherein one of the first positions of the vehicle stored in the memory is determined as the parking position of the vehicle when its distance from the last position plus the associated first positioning error is smaller than the last positioning error or a last positioning error scaled using a specified scaling factor.

This application claims priority under 35 U.S.C. § 119 to application no. DE 102022204409.6, filed on May 4, 2022 in Germany, the disclosure of which is incorporated herein by reference in its entirety.

### BACKGROUND

The present disclosure relates to a method for determining a parking position of a vehicle.

Electric bikes provide an efficient and comfortable method of travel. In this context, electric bikes are often comparatively expensive and are thus also a popular target for thieves.

In order to prevent theft of electric bikes or to recover the bike after theft, electric bikes are often equipped with positioning systems, which in particular include a GNSS receiver. Thus, either a current position of the vehicle can be determined after a theft, or it can be detected when the bike is removed from a parking position without permission. In any case, it is desirable to detect a parking position of the vehicle as accurately as possible.

### SUMMARY

The method according to the disclosure for determining a parking position of a vehicle comprises detecting first positions of the vehicle in a temporally successive sequence by a GNSS receiver and storing these positions in a memory, an associated first positioning error being stored for each of the first positions; detecting a final position of the vehicle with an associated final positioning error by the GNSS receiver in response to the vehicle being transferred into a parked state; and determining the parking position of the vehicle, one of the first positions of the vehicle stored in the memory being determined as the parking position of the vehicle when its distance from the last position plus the associated first positioning error is smaller than the last positioning error or a last positioning error scaled using a specified scaling factor.

The apparatus according to the present disclosure for determining a parking position of a vehicle comprises a control unit, which is configured to detect first positions of the vehicle in a temporally successive sequence by a GNSS receiver and store these positions in a memory, an associated first positioning error being stored for each of the positions; to detect a final position of the vehicle with an associated final positioning error by the GNSS receiver in response to the vehicle being transferred into a parked state; and to determine the parking position of the vehicle, one of the first positions of the vehicle stored in the memory being determined as the parking position of the vehicle when its distance from the last position plus the associated first positioning error is smaller than the last positioning error or a last positioning error scaled using a specified scaling factor.

Preferably, the vehicle is an electric bike. The GNSS receiver is in particular a GPS receiver, a GLONASS receiver, or a Galileo receiver. With such GNSS receivers, a current position of the GNSS receiver is continuously determined and provided. The positions provided by the GNSS receiver are detected as first positions. The detection of the first positions occurs during regular operation of the vehicle.

Typically, information is also provided by a GNSS receiver indicating how precise a respective detected position is. This information is considered a positioning error and is preferably provided as a distance or converted into a distance by means of a corresponding conversion formula. The positioning error thus indicates the maximum distance of a vehicle from a detected position. The positioning error is thus a value that typically increases when a reception quality of the GNSS receiver drops. Thus, a GNSS receiver outdoors typically has a comparatively good reception, and the positioning error is comparatively small. If the GNSS receiver is moved into a closed building, the reception of the GNSS receiver is comparatively poor and the positioning error increases.

A last position of the vehicle is also detected. The last position is also detected by means of the GNSS receiver and performed in the same manner as the first positions. However, the last position is not necessarily stored in the same memory in which the first positions are stored. The last positioning error is stored for the last position. The last position is detected when the vehicle is transferred into a parked state. In this context, a parked state is a state in which it is assumed that no further movement of the vehicle will take place for the time being. In principle, therefore, it is to be assumed that the vehicle is in the parking position at a time of detection of the last position. However, the positioning error must in this case be considered, which results in the detected last position not necessarily being exactly the position where the vehicle is actually located. In some cases, it is advantageous to determine one of the previously detected first positions as the parking position, because this results in a higher precision than directly using the last position of the vehicle as the parking position.

Accordingly, the parking position of the vehicle is determined based on the first positions and the last position as well as the associated positioning errors. One of the first positions is in this case determined as the parking position of the vehicle when its distance from the last position plus the associated first positioning error is less than the specified positioning error. Optionally, the last positioning error is in this case previously scaled using a scaling factor. As a result, a weighting of the last position of the vehicle can be made. By considering the positioning errors alone, it can already be determined which of the first positions has a particularly high accuracy. The distance between the respective positions and the last position takes into account that the vehicle has moved forward since the detection of this position and the transfer into the parked state. By combining the positioning error and the distance from the last position, it can be ensured that a particularly precise position of the vehicle is selected as the parking position.

The method is advantageous, because bikes in particular are moved into enclosed buildings just before they are parked. For example, it is often normal for the bikes to be parked in a bicycle basement. Thus, just prior to parking the bike, the positioning error increases and the precision for detecting a current position decreases. Especially in such cases, it is particularly advantageous to select a position previously determined as the parking position of the vehicle, in particular a position that was detected by the GNSS receiver just before the vehicle was moved into the building. Similar situations also arise for other vehicles, as well as for passenger cars that are moved into a subterranean parking lot, for example.

A method and an apparatus are thus created, by means of which a parking position of a vehicle is reliably determined after the vehicle has been moved. Positions are detected by the GNSS receiver, which is preferably integrated into a control unit.

Preferred embodiments of the disclosure are further set forth below.

Preferably, upon determining the parking position of the vehicle, the last position is determined as the parking position of the vehicle when it is true for all stored first positions that their distance from the last position plus the respective positioning error is greater than the last positioning error. Thus, situations can also occur in which the last position best describes the parking position of the vehicle. This is in particular the case when the first positions either all have a particularly large positioning error and/or a large distance from the last position. In practice, this covers scenarios in which the GNSS receiver has a good reception at the time the vehicle is transferred into the parked state and receives a last position with a low positioning error.

It is also advantageous when, among the stored first positions of the vehicle, the one for which a sum of its distance from the last position plus the associated first positioning error is the smallest is determined as the parking position of the vehicle. If multiple first positions are thus available for selection in order to be determined as the parking position of the vehicle, it is advantageous when the position is selected that is particularly close to the last position and has the lowest possible positioning error. The distance and the positioning error can in this case be evaluated in the same way.

Preferably, a position of the vehicle detected by the GNSS receiver is only stored as a first position in a memory when a speed of the vehicle associated with the position is less than a specified speed threshold. Thus, positions at which the vehicle has a comparatively high speed are not considered. This is therefore advantageous because, due to the present speed, such a position is expected to be far from an actual parking position. The speed is determined either by means of the GNSS receiver or based on an alternative speed sensor.

Preferably, a position of the vehicle detected by the GNSS receiver is only stored as a first position in a memory when a speed of the vehicle associated with the position is less than a speed associated with a position previously detected by the GNSS receiver. A newly detected position is thus only stored when the vehicle slows down and a parking operation is therefore to be expected.

It is also advantageous for the memory to have a limited number of memory locations. The number of memory locations is in this case preferably a predefined number of memory locations. This limited number is preferably selected such that the first positions stored in the memory can be analyzed within a predefined time interval when the vehicle is parked.

It is advantageous when a newly detected first position with its associated positioning error is not stored in the memory when it is true for all previously stored first positions that their distance from the newly detected position plus the respective first positioning error of the previously stored first positions is less than the last positioning error of the newly detected position. Thus, not all detected first positions are stored in the memory. For example, positions that describe the current position of the vehicle worse already at the time of storing are not stored. This can be detected by comparing the previously stored first positions with the positioning error of the newly detected position.

It is also advantageous when, if a first position stored in the memory is overwritten by a newly detected first position, then, among the stored first positions, the one for which a sum of its distance from the newly detected first position plus the associated first positioning error is the largest is overwritten. Thus, the position is selected which describes a current position of the vehicle in the least robust manner, or in the worst manner. This is typically the position that has the greatest distance from the last detected position and the greatest positioning error, or the sum thereof. Thus, when storing the first positions, the position in the memory which worst describes the current position is always overwritten.

It is also advantageous when a first position in the memory is overwritten by a newly detected first position only when the memory has no free memory location. Especially at the beginning of the method, the memory typically has free memory locations, which are initially filled before existing memory locations are overwritten.

It is also advantageous when the scaling factor is a value between 0 and 1. Thus, a weighting of the last position can be increased when determining the parking position. Alternatively or additionally, the first positions are applied to a further scaling factor, the further scaling factor preferably being time-based, and the sum of the first positioning error and the distance from the first position to the last position being increased in a time-dependent manner using the further scaling factor. This means that particularly old first positions are considered less relevant and less likely to be selected as the parking position of the vehicle.

It is also advantageous when it is determined that the vehicle is being transferred into the parked state when a speed of the vehicle drops to 0 km/h, the vehicle is deactivated, or an operational component of the vehicle is removed. For example, the operating component is a battery or a control unit of the vehicle. It is also advantageous when it is determined that the vehicle is being transferred into the parked state when it is detected that a speed of the vehicle is equal to 0 km/h over a predefined time interval.

### BRIEF DESCRIPTION OF THE DRAWINGS

Exemplary embodiments of the disclosure are described in detail below with reference to the accompanying drawings. The drawings include:

FIG. 1 a schematic illustration of a vehicle 1 having an apparatus for determining a parking position of the vehicle, and

FIG. 2 a schematic illustration of a movement of the vehicle prior to a parking of the vehicle.

### DETAILED DESCRIPTION

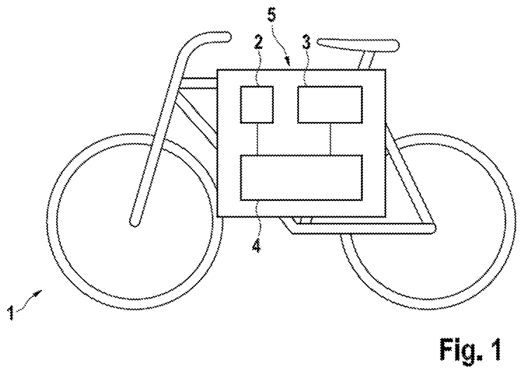

FIG. 1 shows a vehicle 1 having an apparatus arranged therein for determining a parking position of the vehicle 1. The vehicle 1 is in this case an electric bike. The apparatus comprises a control unit 4 configured to carry out the method according to the disclosure.

The apparatus further comprises a GNSS receiver 2 configured to detect current positions of the vehicle 1 and provide them to the control unit 4 for further processing. In addition to a detected position, the GNSS receiver 2 in this case also provides a respective associated positioning error, which describes how far the detected position maximally deviates from an actual position of the GNSS receiver 2. The positioning error is thus a parameter that describes an accuracy of a detected position.

The GNSS receiver 2 features a sampling frequency of 1/60 to 10 Hz.

The apparatus further comprises a memory 3 having a limited number of memory locations. For example, the memory 3 has sufficient memory locations in order to store 5 to 200 detected positions of the vehicle 1 with associated first positioning errors.

If the vehicle 1 is put into operation, the GNSS receiver 2 continuously detects current positions of the vehicle 1. The sampling frequency of the GNSS receiver 2 for detecting positions is typically 1 Hz, but can be in a range of 1-60 Hz. A position is described by a longitudinal and a latitudinal component.

These positions of the vehicle 1 are written as first positions into the memory 3 by the control unit 5. A respective associated first positioning error 15, 16, 17 is in this case stored in the memory 3 for each of the first positions 11, 12, 13. Newly detected positions are stored in the memory 3 as first positions 11, 12, 13 until the memory 3 is filled.

A position of the vehicle detected by the GNSS receiver is only stored as a first position in a memory when a speed of the vehicle associated with the position is less than a specified speed threshold.

Also, a position of the vehicle detected by the GNSS receiver is only stored as a first position in a memory when a speed of the vehicle 1 associated with the position is less than a speed associated with a position immediately previously detected by the GNSS receiver, i.e., when the vehicle is braked or slows down.

If a further position is detected during further operation of the vehicle 1, i.e., a newly detected first position is provided by the GNSS receiver 2, it is checked whether this position is to be stored in the memory 3. The newly detected first position is in this case not stored in the memory 3 when it describes a current position of the vehicle 1 less precisely than all first positions 11, 12, 13 already stored therein. In order to determine this, all previously stored first positions 11, 12, 13 are considered, and it is determined whether their distance from the newly detected position plus the respective first positioning error 15, 16, 17 of the previously stored first positions 11, 12, 13 is less than the last positioning error of the newly detected position. Thus, the last positioning error of the newly detected position is used as the comparison value.

The following testing process is thus performed for each first position previously stored in the memory 3:

Error(i)<Error(k)+distance between position i and position k

The value Error(x) in this case describes the associated positioning error of a position x. In this context, x=i is the newly detected first position, and k defines an index of the stored first positions 11, 12, 13. Each of the stored first positions 11, 12, 13 of the vehicle 1 is considered, and it is checked whether it is better or worse than a newly detected first position. If the previously specified condition is satisfied, the newly detected first position is stored in the memory 3 and overwrites the previously stored first positions 11, 12, 13 for which the condition is satisfied. If the previously specified condition is not met, then the newly detected first position is discarded.

If the newly detected first position is to be written to the memory 3, it is advantageous when this newly detected position overwrites a previously stored first position 11, 12, 13 that worst describes the current position of the vehicle 1. For this purpose, among the stored first positions 11, 12, 13, the one for which a sum of its distance from the newly detected first position 14 plus the associated first positioning error 15, 16, 17 is the largest is overwritten.

If the vehicle 1 is moved for the first time after parking, it may be the case that no first positions are stored in the memory 3. It is therefore preferable that a first position 11, 12, 13 in the memory be overwritten by a newly detected first position only when the memory 3 no longer has any free memory locations. It is also optionally advantageous when storage in the memory 3 is only considered for newly detected first positions when a speed of the vehicle 1 is above a predefined threshold. In particular, it is not necessary for new positions to be continuously written to the memory 3 when the vehicle 1 is standing. Thus, it is also avoided that, in the event of minimal movement or no movement of the vehicle 1, all of the last stored first positions 11, 12, 13 immediately prior to a parking of the vehicle 1 can be overwritten before a parking position of the vehicle 1 is determined.

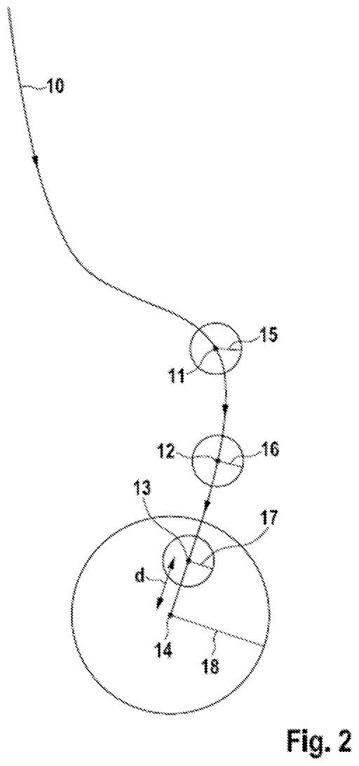

If it is detected that the vehicle 1 is parked, e.g., by determining that a speed of the vehicle drops to 0 km/h, the vehicle is deactivated, or an operating component of the vehicle 1 is removed, e.g., a battery or a speedometer of the vehicle 1 is removed, then a last position 14 of the vehicle 1 is detected. An associated last positioning error 18, which is associated with the last position 14, is also detected in this case. This is also done by the GNSS receiver 2 in a manner similar to the detection of the first positions 11, 12, 13. However, the last position 14 and the last positioning error 18 are not written to the memory 3, but rather are used in order to determine the parking position of the vehicle 1. This process is described below by way of example, based on the exemplary scenario in FIG. 2.

FIG. 2 shows a trajectory 10, along which the vehicle 1 has been moved before the vehicle 1 is parked. The vehicle 1 was parked at the last position 14. Previously, first positions 11, 12, 13 were detected while the vehicle 1 was moving along the trajectory 10. Each of the detected positions, i.e., the first positions 11, 12, 13 as well as the last position 14, have a positioning error. The first positions 11, 12, 13 shown in FIG. 2 have the first positioning errors 15, 16, 17. The last position 14 has the last positioning error 18. The positioning errors are indicated in FIG. 2 as circles circumscribing the respective associated position. This illustrates that the positioning error defines an inaccuracy by which it is described how far an actual position detected by the GNSS receiver 2 can deviate from the actual position of the vehicle 1. Using the example of the last position 14, this means that the vehicle 1 is not necessarily exactly at the last position 14 detected by the GNSS receiver 2, but is highly likely to be within the circle defined by the last positioning error 18. This also applies accordingly for the first positions 11, 12, 13.

In the scenario illustrated in FIG. 2, the vehicle 1 was moved along the trajectory 10 and moved into a closed building shortly prior to the vehicle 1 being transferred into the parked state. Thus, the final positioning error 18 is significantly greater than the first positioning errors 15, 16, 17 of the first positions 11, 12, 13. In particular, it can be seen that the last detected first position 13 can in this case describe the parking position of the vehicle 1 more precisely than the last position 14, because the last position 14 has a particularly high last positioning error 18. Thus, the detected last position 14 with the associated last positioning error 18 enables the vehicle 1 to theoretically even be located along the trajectory 10 before the last detected first position 13, because it cannot be safely assumed that the vehicle 1 is exactly at the detected last position 14.

In order to determine the parking position of the vehicle 1, one of the stored first positions 11, 12, 13 is determined as the parking position of the vehicle 1 when its distance from the last position 14 plus the associated first positioning errors 15, 16, 17 is smaller than the last positioning error 18 or a last positioning error 18 scaled using a specified scaling factor.

For example, the last detected first position 13 is considered. The sum of the distance d between the last first position 13 and the last position 14 of the vehicle 1 is determined. This distance d between the last position 14 and the last first position 13 is applied to the first positioning error 17 of the last detected first position 13. The result is that the sum of these two distances is less than the last positioning error 18. In other words, this means that the circle defined by the last first positioning error 17 lies within the circle defined by the last positioning error 18. In this case, it is not the last position 14, but rather the last detected first position 13 that is selected as the parking position of the vehicle 1.

It can further be seen that, for the first positions 11, 12 detected prior to the last detected first position 13, the sum of their distance from the last position 14 and their first positioning error is greater than the last positioning error 18. These first positions 11, 12 are thus not determined as the parking position of the vehicle 1. According to FIG. 2, this is therefore advantageous because the vehicle 1 according to the detected last position 14 is very likely to be within the circle described by the last positioning error 18 and thus not within the range of the initially detected first positions 11, 12. Given that a plurality of first positions can also be located within the circle defined by the last positioning error 18, it is advantageous when the position for which a sum of its distance from the last position 14 plus the associated first positioning error 15, 16, 17 of the respective first position 11, 12, 13 is the smallest is determined as the parking position of the vehicle 1.

In alternative scenarios, it can also result that the detected last position 14 best describes the parking position of the vehicle 1. This is the case when it is true for all stored first positions 11, 12, 13 that their distance from the last position 14 plus the respective first positioning error 15, 16, 17 is greater than the last positioning error 18. In this case, the detected last position 14 is determined as the parking position of the vehicle 1.

In addition to the written disclosure made hereinabove, explicit reference is made to the disclosure of FIGS. 1 and 2.

What is claimed is:

1. A method for determining a parking position of a vehicle, comprising:
detecting first positions of the vehicle in a temporally successive sequence by a GNSS receiver and storing these positions in a memory, wherein an associated first positioning error is stored for each of the first positions;
detecting a final position of the vehicle with an associated final positioning error by the GNSS receiver in response to the vehicle being transferred into a parked state, and
determining the parking position of the vehicle, wherein one of the first positions of the vehicle stored in the memory is determined as the parking position of the vehicle when its distance from the last position plus the associated first positioning error is smaller than the last positioning error or a last positioning error scaled using a specified scaling factor.

2. The method according to claim 1, wherein, upon determining the parking position of the vehicle, the last position is determined as the parking position of the vehicle when it is true for all stored first positions that their distance from the last position plus the respective positioning error is greater than the last positioning error.

3. The method according to claim 1, wherein, among the stored first positions of the vehicle, the one for which a sum of its distance from the last position plus the associated first positioning error is the smallest is determined as the parking position of the vehicle.

4. The method according to claim 1, wherein a position of the vehicle detected by the GNSS receiver is only then stored as a first position in a memory when a speed of the vehicle associated with the position is less than a specified speed threshold, and/or a speed of the vehicle associated with the position is less than a speed associated with a position previously detected by the GNSS receiver.

5. The method according to claim 1, wherein a newly detected first position with its associated positioning error is not stored in the memory when it is true for all previously stored first positions that their distance from the newly detected position plus the respective first positioning error of the previously stored first positions is less than the last positioning error of the newly detected position.

6. The method according to claim 1, wherein, if a first position stored in the memory is overwritten by a newly detected first position, then among the stored first positions, the one for which a sum of its distance from the newly detected first position plus the associated first positioning error is the largest is overwritten.

7. The method according to claim 1, wherein a first position in the memory is overwritten by a newly detected first position only when the memory has no free memory location.

8. The method according to claim 1, wherein the scaling factor is a value between 0 and 1, and/or the memory has a limited number of memory locations.

9. The method according to claim 1, wherein it is determined that the vehicle is being transferred into the parked state when a speed of the vehicle drops to 0 km/h, the vehicle is deactivated, an operating component of the vehicle is removed, and/or when it is detected that a speed of the vehicle is equal to 0 km/h over a predefined time interval.

10. An apparatus for determining a parking position of a vehicle, comprising a control unit configured to:
detect first positions of the vehicle in a temporally successive sequence by a GNSS receiver and to store these positions in a memory, wherein an associated first positioning error is stored for each of the first positions,
detect a final position of the vehicle with an associated final positioning error by the GNSS receiver in response to the vehicle being transferred into a parked state, and
determine the parking position of the vehicle, wherein one of the first positions of the vehicle stored in the memory is determined as the parking position of the vehicle when its distance from the last position plus the associated first positioning error is smaller than the last positioning error or a last positioning error scaled using a specified scaling factor.
